(19) United States
(12) Patent Application Publication
(10) Pub. No.: US 2004/0071318 A1
(43) Pub. Date: Apr. 15, 2004

(54) Apparatus and method for recognizing images

(76) Inventors: Humphrey Cheung, Hong Kong SAR (CN); Johnny Ng, Hong Kong SAR (CN)

Correspondence Address: BURNS, DOANE, SWECKER & MATHIS, L.L.P., P.O. Box 1404, Alexandria, VA, 22313-1404, US

(21) Appl. No.: 10/306,207

(22) Filed: Nov. 29, 2002

(30) Foreign Application Priority Data
Oct. 9, 2002 (HK) 02107388.3

(51) Int. Cl. G06K 9/00

(52) U.S. Cl. 382/104

(57) ABSTRACT

One of the major courses of travel accidents is due to drivers' fatigue or drowsiness. One approach to resolve this issue is to detect the motion or face expression of the drivers. Such methods heavily rely on the images captured for processing. However, the driving environment may change rapidly when the vehicle moves and may severely affect quality of the images captured. This invention provides a plurality of primary image-capturing devices for capturing images of the driver. Each of the individual primary image-capturing device is adjusted to have a different value in a particular capturing setting, particularly the exposure, to increase the chance in capturing at least one image having suitable quality for further processing.

### FIELD OF THE INVENTION

This invention relates to apparatus and method for recognizing images, particularly those where the images are exposed to rapidly changing driving environment.

### BACKGROUND OF THE INVENTION

One of the major courses of travel accidents is due to drivers' fatigue or drowsiness. In order to alert the driver in such situations, it may be necessary to develop suitable methods to identify whether the drivers are awake. Otherwise, the alerting method may become harassment to the driver.

Generally, the above detection method may be classified into three categories:

a) The driver has to interact with a device to indicate that they are still awake repeatly. The device may be as simple as a press button or speech-recognizing device. However, this can be relatively annoying to the driver.

b) Putting specific devices onto the driver to monitor suitable physiological parameters, like heart beat. However, the accuracy may be in doubt and substantial adjustment may be required for different individuals, apart from the annoyance to the driver.

c) Monitoring the driver passively through his motions or face expression.

The third approach is the most convenient and user friendly among the currently available approaches. A number of US patents describe patent recognition technology to detect the openness of the drivers' eyes to determine whether the driver is awake. Alternative method may rely on detecting the difference between the faces of a driver at different times. Relevant examples may be found in U.S. Pat. Nos. 6,087,941, 6,252,978, and 6,400,853.

All of the above methods heavily rely on the quality of the images captured by the image-capturing device. However, the driving environment may change rapidly when the vehicle moves and may severely affect quality of the images captured. For instance, the light from the environment may change rapidly when the vehicle enters or leave a tunnel. This may require extra tuning in the processing unit to prevent faulty alarms, if possible. This may increase the overall complexity and decrease the overall accuracy of the detection method.

### OBJECTS OF THE INVENTION

Therefore, it is an object of this invention to resolve at least one or more of the problems as set forth in the prior art. As a minimum, it is an object of this invention to provide the public with a useful choice.

### SUMMARY OF THE INVENTION

Accordingly, this invention provides an apparatus for recognizing images including

a plurality of primary image-capturing devices arranged to capture images from a first direction; and

a processing device operatively connected to the image-capturing devices for processing the image

The apparatus of this invention is characterized in that each of the primary image-capturing device has a capturing setting different from each other.

Preferably, the capturing setting is an exposure setting.

More preferably, the primary image-capturing devices are set at auto exposure mode, especially if the primary image-capturing devices have less than five primary image-capturing devices.

Alternatively, the image-capturing devices are set at fixed exposure mode, especially if the primary image-capturing devices have more than five primary image-capturing devices.

Optionally, the apparatus of this invention further includes a light source for providing background lighting. Preferably the light source is an infrared emitter.

Additionally, the apparatus of this invention further includes at least one secondary image-capturing device arranged to capture images from a second direction.

It is a second aspect of this invention to provide a method of recognizing images including the steps of:

capturing said images by a plurality of primary image-capturing devices arranged to capture said images from a first direction; and

processing and recognizing the captured images by a processing device

characterized in that each of the primary image-capturing device has an exposure setting different from each other.

It is a third aspect of this invention to provide an apparatus for capturing images including a plurality of image-capturing devices arranged to capture images from a first direction

characterized in that each of the image-capturing device has a capturing setting different from each other.

### BRIEF DESCRIPTION OF THE DRAWINGS

Preferred embodiments of the present invention will now be explained by way of example and with reference to the accompany drawings in which:

FIG. 1 shows the general arrangement of the image detection apparatus of this invention; and

FIG. 2 shows the pictures of different exposure settings that are captured by the image-capturing device of this invention.

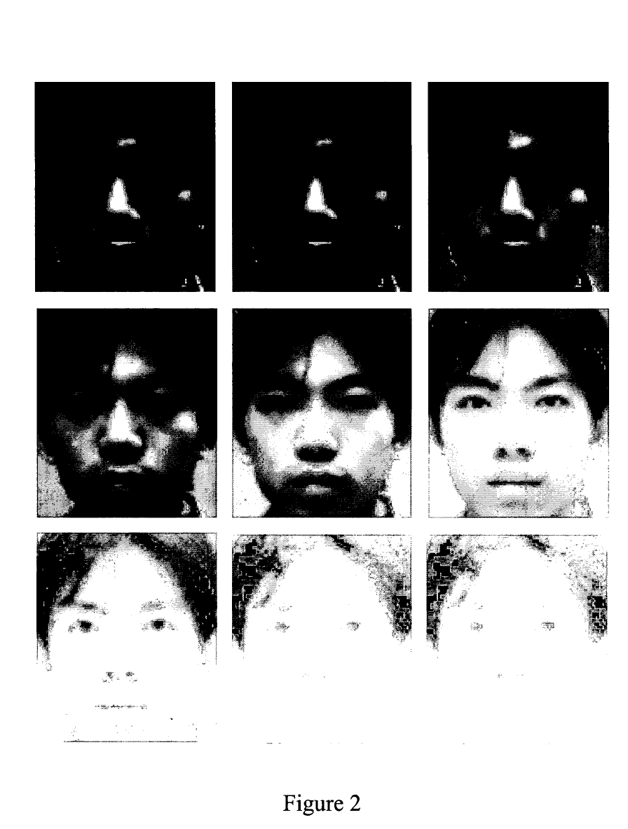

### DETAILED DESCRIPTION OF THE PREFERRED EMBODIMENTS

This invention is now described by ways of example with reference to the figures in the following paragraphs. List 1 is a part list so that the reference numerals in the figures may be easily referred to.

Objects, features, and aspects of the present invention are disclosed in or are obvious from the following description. It is to be understood by one of ordinary skill in the art that the present discussion is a description of exemplary embodiments only, and is not intended as limiting the broader aspects of the present invention, which broader aspects are embodied in the exemplary constructions.

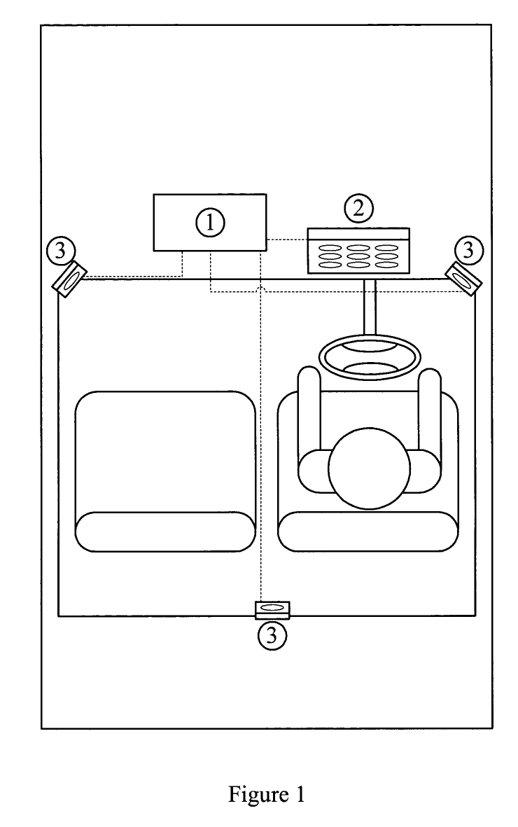

FIG. 1 shows the general arrangement of the image detection apparatus of this invention. The image processing device 1 is responsible for processing the images captured from the primary image-capturing device 2. Additional secondary image-capturing devices 3 may be provided to captured the face images of the driver when the driver turns his head. The processing device 1 can be an ordinary computer unit having sufficient computing power for processing the images captured. A suitable algorithm may be incorporated. The algorithm itself is not the subject of this invention and further discussion may be found in the following documents:

System for monitoring eyes for detecting sleep behavior (U.S. Pat. No. 5,570,698)

Detection of the open/closed state of eyes based on analysis of relation between eye and eyebrow images in input face images (U.S. Pat. No. 5,878,156)

Apparatus for determing the alertness of a driver (U.S. Pat. No. 6,097,295)

Driver's eye detecting method of drowsy driving warning system (U.S. Pat. No. 6,130,617)

Driver's drowsiness detection method of drowsy driving warning system (U.S. Pat. No. 6,243,015 B1)

Method and device for detecting drowsiness and preventing a driver of a motor vehicle from falling asleep (U.S. Pat. No. 6,304,187 B1)

Eye activity monitor (U.S. Pat. No. 6,346,887 B1)

This invention may be characterized in the provision of the plurality of primary image-capturing devices 2 for capturing images of the driver from a first direction. This plurality of primary image-capturing devices may be arranged as an array. Each of the individual primary image-capturing device 2 is adjusted to have a different value in a particular capturing setting. The number of the primary image-capturing devices 2 may be as few as two even though this may affect the overall accuracy. On the other hand, providing too many primary image-capturing devices 2, say fifteen to twenty, will increase costs. This may be a factor to be determined by the system provider.

Particularly, each of the individual capturing devices may be adjusted to have an exposure setting different from each other to handle the change in light from the environment. This will be detailed in the following sections.

Other settings of the image-capturing devices may be adjusted to be different from each other, like focus or focal length. However, these settings may be of less practical value. For example, when the primary image-capturing devices 2 are arranged in an array and are of the same distance from the driver, their focus should be the same. On the other hand, this shall not limit the varying parameter among the image-capturing devices to be exposure setting only.

In following specific embodiments, the camera arrays are made up of cameras with different exposure settings. The resultant exposure value is determined by the aperture and the shutter speed (duration of exposure). Apparatus made use of this invention may control either, or both, parameters in order to control the final exposure of an individual camera. Controlling the shutter speed may be the much cost effective approach in most designs.

To further enhance the accuracy or deal with the situation where the driver turns his head, additional secondary image-capturing devices 3 may be provided. This can be a single image-capturing device or it can be an image-capturing device array similar to the first plurality of image-capturing devices 2. As shown in FIG. 1, there can be three secondary image-capturing devices 3 each capturing images from a different secondary direction. The provision of such secondary image-capturing devices may increase cost, but this factor may be left for the system provider to decide.

A wide variety of image-capturing devices can be used in this invention. Of course, electronic devices are preferred over their optical counterparts for prompt processing. These may include CMOS (complementary metal oxide semiconductor) or CCD (Charged Couple Device) devices having suitable resolution, say, 320 times 240 to 160 times 120 pixels or even less. The resolution required is subjected to the algorithm incorporated in the image-processing device.

Additionally, a light source may be provided to deal with dark environment (not shown in the Figures). The light source is preferably an infrared emitter to avoid disturbing the driver. In such a case, the image-capturing devices should be capable of sensing infrared light. Although the light source can be placed anywhere, it is preferable to position the light source with the primary image-capturing devices to provide maximum lux along the first direction.

In this invention, the camera arrays can be configured either of the following two modes:

A. Auto Exposure Mode

In this mode, all member cameras in the array are configured in auto exposure mode, but with different exposure compensation, by, for example, adjusting the shutter speed. For example, there may be three cameras in the array, namely Camera A, B and C. Camera A is configured without any exposure compensation, but Camera B is configured to be overexposed by 1 (double the shutter speed) and Camera C is configured to be underexposed by 1 (half the shutter speed). Without loss of generality, the “step” of underexposure and overexposure may be values other than 1.

When the environment lighting is varying rapidly, the mechanism of auto exposure of each individual camera may not be able to function efficiently. In the period of the auto exposure adoption, the secondary image-capturing devices 3 that are configured as underexposed or overexposed may be able to capture pictures with correct exposure value.

B. Fixed Exposure Mode

In this mode, all member cameras in the array are configured in fixed exposure mode but different exposure values. For example, there may be three cameras in the array, namely Camera A, B and C. Camera A is configured as the camera with the lowest exposure value. For example, in the case where an infra-red emitter may be used for the background ambient light, Camera A may configured so that it is correctly exposed with the emitter in the completely dark (0 Lux) environment. Each remaining camera is then configured with the exposure incremented by 1 step, e.g. Camera B will double the shutter speed of Camera A and Camera C will double the shutter speed of Camera B.

In this mode, the settings of the aperture and power of the emitter will be adjusted so that the camera with the lowest exposure value will have a reasonable shutter speed (e.g. 1/30 second). If seven cameras are used in the array, the shutter speed will be 1/30, 1/60, 1/125, 1/250, 1/500, 1/1000, 1/2000 seconds respectively. Increasing the number of the first plurality of image-capturing devices may increase the chance of capturing at least one image having a suitable exposure for processing.

In general, the first approach is optimal for smaller number of cameras (<5) and the second approach is optimal for larger number of cameras (>=5). The first approach is less costly in implementation (less camera is required and infra-red emitter is only optional) while the second approach may be capable of functioning in extreme operation environment.

While the preferred embodiment of the present invention has been described in detail by the examples, it is apparent that modifications and adaptations of the present invention will occur to those skilled in the art. Furthermore, the embodiments of the present invention shall not be interpreted to be restricted by the examples or figures only. It is to be expressly understood, however, that such modifications and adaptations are within the scope of the present invention, as set forth in the following claims. For instance, features illustrated or described as part of one embodiment can be used on another embodiment to yield a still further embodiment. Thus, it is intended that the present invention cover such modifications and variations as come within the scope of the claims and their equivalents.

1. An apparatus for recognizing images including
a plurality of primary image-capturing devices arranged to capture images from a first direction; and
a processing device operatively connected to the image-capturing devices for processing the image
characterized in that each of the primary image-capturing device has a capturing setting different from each other.

2. The apparatus of claim 1, wherein the capturing setting is an exposure setting.

3. The apparatus of claim 2, wherein the primary image-capturing devices are set at auto exposure mode.

4. The apparatus of claim 3 including less than five primary image-capturing devices.

5. The apparatus of claim 2, wherein the image-capturing devices are set at fixed exposure mode.

6. The apparatus of claim 5 including more than five primary image-capturing devices.

7. The apparatus of claim 1 further including a light source for providing background lighting.

8. The apparatus of claim 7, wherein the light source is an infrared emitter.

9. The apparatus of claim 1 further including at least one secondary image-capturing device arranged to capture images from a second direction.

10. A method of recognizing images including the steps of:
capturing said images by a plurality of primary image-capturing devices arranged to capture said images from a first direction; and
processing and recognizing the captured images by a processing device
characterized in that each of the primary image-capturing device has an exposure setting different from each other.

11. The method of claim 10, wherein the capturing setting is an exposure setting.

12. The method of claim 11, wherein the primary image-capturing devices are set at auto exposure mode.

13. The method of claim 12 including less than five primary image-capturing devices.

14. The method of claim 11, wherein the image-capturing devices are set at fixed exposure mode.

15. The method of claim 14 including more than five primary image-capturing devices.

16. The method of claim 10 further including a light source for providing background lighting.

17. The method of claim 16, wherein the light source is an infrared emitter.

18. The method of claim 10 further including the step of capturing images from a second direction by at least one secondary image-capturing device.

19. An apparatus for capturing images including a plurality of image-capturing devices arranged to capture images from a first direction
characterized in that each of the image-capturing device has a capturing setting different from each other.

20. The apparatus of claim 19, wherein the capturing setting is an exposure setting.

21. The apparatus of claim 20, wherein the primary image-capturing devices are set at auto exposure mode.

22. The apparatus of claim 21 including less than five image-capturing devices.

23. The apparatus of claim 20, wherein the image-capturing devices are set at fixed exposure mode.

24. The apparatus of claim 23 including more than five primary image-capturing devices.
